(19) United States
(12) Patent Application Publication
(10) Pub. No.: US 2022/0164604 A1
(43) Pub. Date: May 26, 2022

(54) CLASSIFICATION DEVICE, CLASSIFICATION METHOD, AND CLASSIFICATION PROGRAM

(71) Applicant: NIPPON TELEGRAPH AND TELEPHONE CORPORATION, Tokyo (JP)

(72) Inventors: Sekitoshi KANAI, Tokyo (JP); Hiroshi TAKAHASHI, Tokyo (JP)

(73) Assignee: NIPPON TELEGRAPH AND TELEPHONE CORPORATION, Tokyo (JP)

(21) Appl. No.: 17/602,282

(22) PCT Filed: Mar. 26, 2020
(86) PCT No.: PCT/JP2020/013689

§ 371 Date: Oct. 8, 2021

(30) Foreign Application Priority Data
Apr. 11, 2019 (JP) 2019-075317

(51) Int. Cl. G06K 9/62; G06F 16/906; G06N 3/04; G06N 3/08

(52) U.S. Cl. CPC G06K 9/6259; G06N 3/08; G06N 3/04; G06F 16/906

(57) ABSTRACT

A classification device (10) includes: a classification unit (12) that performs classification by using a model (121) that is a model performing classification and is a deep learning model; and a preprocessing unit (11) that is provided prior to the classification unit (12), and selects an input to the model (121) by using a mask model (111) that minimizes a sum of a loss function and a magnitude of the input to the classification unit (12), the loss function evaluating a relationship between a label on an input from teaching data and an output of the model (121).

### TECHNICAL FIELD

The present invention relates to a classification device, a classification method, and a classification program.

### BACKGROUND ART

Deep learning and deep neural networks have achieved great success in image recognition, speech recognition, and the like (for example, see Non-Patent Literature 1). For example, in image recognition using deep learning, when an image is inputted into a model including a large number of non-linear functions for deep learning, a classification result indicating what appears in the image is outputted.

However, when a malicious adversary adds noise optimum for the model to an input image, the subtle noise can easily cause misclassification in deep learning (for example, see Non-Patent Literature 2). This is called an adversarial attack, and some attack methods, such as FGSM (Fast Gradient Sign Method) and PGD (Projected Gradient Descent), have been reported (for example, see Non-Patent Literatures 3, 4).

To allow a model to have robustness against such adversarial attacks, it has been suggested that of an input, only an element that is strongly correlated with a label may be used (for example, see Non-Patent Literature 5).

### CITATION LIST

### Non-Patent Literature

Non-Patent Literature 1: Ian Goodfellow, Yoshua Bengio, and Aaron Courville, “Deep learning”, MIT press, 2016.
Non-Patent Literature 2: Christian Szegedy, et al, “Intriguing properties of neural networks”, arXiv preprint: 1312.6199, 2013.
Non-Patent Literature 3: Ian J. Goodfellow, et al., “EXPLAINING AND HARNESSING ADVERSARIAL EXAMPLES”, arXiv preprint: 1412.6572, 2014.
Non-Patent Literature 4: Aleksander Madry, et al., “Towards Deep Learning Models Resistant to Adversarial Attacks”, arXiv preprint: 1706.06083, 2017.
Non-Patent Literature 5: Dimitris Tsipras, et al., “Robustness May Be at Odds with Accuracy”, arXiv preprint: 1805.12152, 2018.

### SUMMARY OF THE INVENTION

### Technical Problem

As described above, the problem has been addressed that deep learning is vulnerable to adversarial attacks and misclassification results. Moreover, since deep learning includes complicated non-linear functions, there has been a problem that a reason for a determination made when something is classified is unclear.

The present invention has been made in view of the above-describe problems, and an object of the present invention is to provide a classification device, a classification method, and a classification program that achieve robustness, and make it easy to account for which element of an input is used in performing classification.

### Means for Solving the Problems

To solve the problems and achieve the object, a classification device according to the present invention includes: a classification unit that performs classification by using a first model that is a model performing classification and is a deep learning model; and a preprocessing unit that is provided prior to the classification unit, and selects an input to the first model by using a second model that minimizes a sum of a loss function and a magnitude of the input to the classification unit, the loss function evaluating a relationship between a label on an input from teaching data and an output of the first model.

### Effects of the Invention

According to the present invention, it is possible to achieve robustness, and to make it easy to account for which element of an input is used in performing classification.

### BRIEF DESCRIPTION OF DRAWINGS

FIG. 1 is a diagram for describing a deep learning model.

FIG. 2 is a flowchart showing a processing procedure of learning processing by a conventional classifier.

FIG. 3 is a block diagram showing an example of a configuration of a classification device according to an embodiment.

FIG. 4 is a diagram for describing an outline of a model structure in the embodiment.

FIG. 5 is a diagram for describing a flow of processing involving a mask model.

FIG. 6 is a flowchart showing a processing procedure of learning processing in the embodiment.

FIG. 7 shows an example of a computer on which a program is executed and thereby the classification device is implemented.

### DESCRIPTION OF EMBODIMENT

Hereinafter, an embodiment of the present invention will be described in detail with reference to drawings. Note that the present invention is not limited by the embodiment. In description of the drawings, the same portions are denoted by the same reference signs.

[Deep Learning Model]

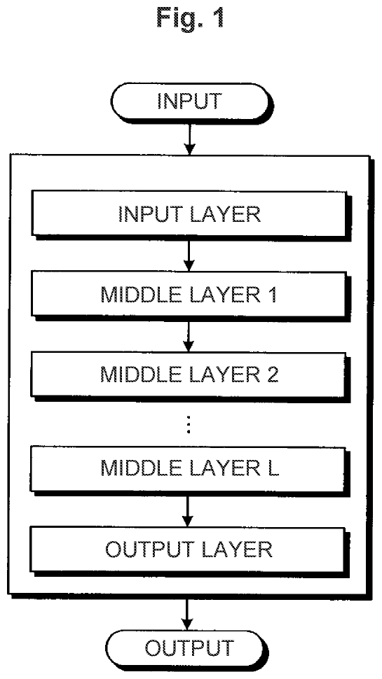

First, a deep learning model will be described. FIG. 1 is a diagram for describing a deep learning model. As shown in FIG. 1, a deep learning model includes an input layer to which a signal is inputted, one or more middle layers that convert the signal from the input layer into various signals, and an output layer that converts the signals from the middle layers into an output such as a probability.

Input data is inputted into the input layer. A probability of each class is outputted from the output layer. For example, the input data is image data represented in a predetermined format. For example, when a class is set for each of vehicle, boat, dog, and cat, a probability that an object appearing in an image from which the input data derives is a vehicle, a probability that the object is a boat, a probability that the object is a dog, and a probability that the object is a cat are outputted from the output layer.

[Learning Method by Conventional Classifier]

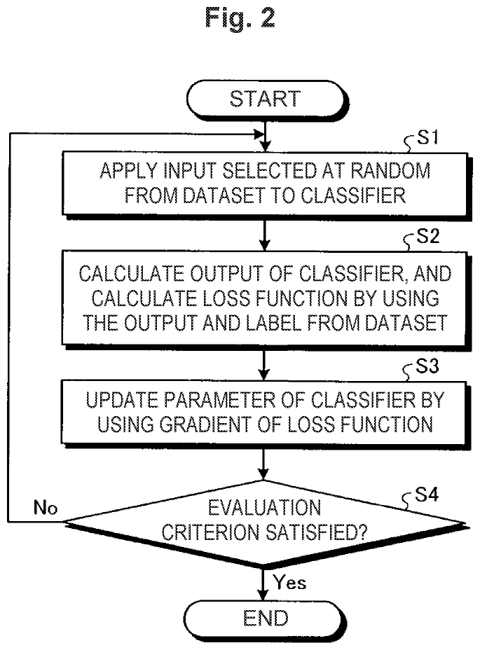

Conventional learning by a classifier including a deep learning model will be described. FIG. 2 is a flowchart showing a processing procedure of learning processing by a conventional classifier.

As shown in FIG. 2, in the conventional learning processing, an input and a label are selected at random from a dataset that is prepared beforehand, and the input is applied to the classifier (step S1). In the conventional learning processing, an output of the classifier is calculated, and a loss function is calculated by using the output and the label from the dataset (step S2).

In the conventional learning processing, learning is performed such that calculated results of the loss function become smaller, and a parameter of the classifier is updated by using a gradient of the loss function (step S3). For the loss function, a function that yields a smaller value as an output of the classifier and a label match better is set in general, and consequently the classifier becomes able to classify a label on an input.

In the conventional learning processing, an evaluation criterion is whether a separately prepared dataset can be correctly classified, or the like. In the conventional learning processing, when the evaluation criterion is not satisfied (step S4: No), the processing returns to step S1, and the learning is continued. When the evaluation criterion is satisfied (step S4: Yes), the learning is terminated.

[Image Recognition by Deep Learning]

As an example of classification processing, image recognition processing by deep learning will be described. Here, in deep learning, a problem is considered in which an image x∈R^{C×H×W} is recognized, and a label y of the image is found among M labels. Here, x is represented by a column vector, and R is represented by a matrix. It is assumed that C is the number of channels (three channels in a case of an RGB format) of the image, H is a vertical dimension, and W is a horizontal dimension.

In such a case, an output f(x, θ)∈R^{M} of a deep learning model represents respective scores for the labels, and an element of the output with a largest score, which is obtained by Expression (1), is a result of the recognition by deep learning. Here, f, θ are represented by column vectors.

$$[ Math . 1 ]$$

$$i = {max}_{j} {f}_{j} ( x , θ ) \qquad ( 1 )$$

Image recognition is a form of classification, and f that performs classification is referred to as a classifier. Here, θ is a parameter of the deep learning model, and the parameter is learned from N datasets {(xᵢ, yᵢ)}, i=1, . . . , N that are prepared beforehand. In this learning, a loss function L (x, y, θ) is set that yields a smaller value as it can be more correctly recognized that yᵢ=maxⱼfⱼ(x), such as a cross entropy, and θ is calculated by performing optimization expressed as Expression (2).

$$[ Math . 2 ]$$

$$θ = arg {min}_{θ} {\sum }_{i = 1}^{N} L ( {x}_{i} , {y}_{i} , θ ) \qquad ( 2 )$$

[Adversarial Attack]

Recognition by deep learning has vulnerability, and false recognition can be caused by an adversarial attack. An adversarial attack is formulated by an optimization problem expressed as Expression (3).

$$[ Math . 3 ]$$

$$δ = arg {max}_{δ} {‖ δ ‖}_{p} \\ subject to {y}_{i} \neq {max}_{j} {f}_{j} ( {x}_{i} + δ , θ ) \qquad ( 3 )$$

∥●∥ₚ is an lₚ norm, and p=2 or p=∞ is mainly used for p. This is a problem of finding a noise that causes false recognition and has a smallest norm, and attack methods using a gradient of a model, such as FGSM and PGD, have been proposed.

[Relationship Between Strength of Correlation and Robustness]

To allow a model to have robustness against an adversarial attack, only elements that are strongly correlated with labels may be used. Accordingly, in the present embodiment, a configuration is made such that of an input, only an element that is strongly correlated with a label is inputted into a model, whereby the model is made to have robustness. Hence, a description will be given of correlation between a feature of an input element and a label, and robustness of a model.

A following classification problem will be considered. It is assumed that pairs of an input x∈R^{d+1} and a label, (x, y), follow a distribution D as in Expression (4).

$$[ Math . 4 ]$$

$$y ∼ \{ - 1 , + 1 \} , {x}_{1} = \{ \begin{matrix}+ y , & w . p . p \\ - y , & w . p . 1 - p\end{matrix} , \\ {x}_{2} , … , {x}_{d + 1} ∼ 𝒩 ( η y , 1 ) \qquad ( 4 )$$

where N(ηy, 1) is a normal distribution with mean ηy and variance 1, and p≥0.5. xᵢ is an i-th element (feature) of an input. η is sufficiently large so that a linear classifier f(x)=sign(w_{T}x) with respect to the input x becomes 99% or greater, and is assumed to be, for example, η=Θ(1/√d). x₁ is correlated with a label y with a high probability p, and it is assumed here that p=0.95. Note that a row vector w is a parameter.

In such a case, a standard optimum linear classifier is like Expression (5).

$$[ Math . 5 ]$$

$${f}_{avg} ( x ) = sign ( {w}_{unit}^{T} x ) , {w}_{unit} = {[ 0 , \frac{1}{d} , … , \frac{1}{d} ]}^{T} \qquad ( 5 )$$

In such a case, Expression (6) is greater than 99% when η≥3/√d.

$$[ Math . 6 ]$$

$$Pr [ {f}_{avg} ( x ) = y ] = Pr [ sign ( {w}_{unif} x ) = y ] = Pr [ \frac{y}{d} {\sum }_{i = 1}^{d} 𝒩 ( η y , 1 ) > 0 ] = Pr [ 𝒩 ( η , \frac{1}{d} ) > 0 ] \qquad ( 6 )$$

However, when an adversarial attack of ∥δ∥_{∞}=2η is added here, xᵢ+δᵢ˜N(−ηy, 1), i=2, . . . , d+1. Consequently, a correct-answer rate of the above-mentioned model becomes lower than 1%, and it can be understood that the model is vulnerable to an adversarial attack.

A description will be given of a linear classifier expressed as Expression (7).

[Math. 7]

f(x)=sign(w^{T}x),w=[1,0, . . . ,0]^{T} (7)

When ε is smaller than one, both a normal correct-answer rate and a correct-answer rate after addition of the above-mentioned adversarial attack are the probability p, and, assuming that p=0.95, both can achieve a correct-answer rate of 95%.

As described above, it can be understood that when features x₂, . . . , x_{d+1} are used that are weakly correlated with the label but are large in number, the model is vulnerable to an adversarial attack, although the normal correct-answer rate is high. On the other hand, it can be understood that the model becomes robust to an adversarial attack by using only the feature x₁ that is strongly correlated with the label but is one in number.

Based on the foregoing, in the present embodiment, an element that is weakly correlated with a label is not used, but only an element that is strongly correlated with the label is used as an input to the model, whereby the robust model to an adversarial attack is constructed.

### Embodiment

Next, the embodiment will be described. In the present embodiment, by incorporating the above-described notion that only an element that is strongly correlated with a label is used as an input to a model, a mask model is provided prior to a model of a classification unit. The mask model is configured to perform learning such that only an element that is strongly correlated with a label is automatically inputted into the classifier.

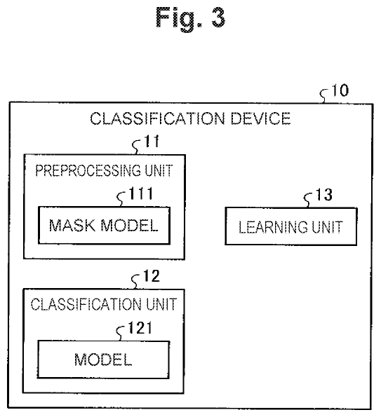

FIG. 3 is a block diagram showing an example of a configuration of a classification device according to the embodiment. The classification device 10 shown in FIG. 3 is implemented in such a manner that a predetermined program is read by a computer or the like including a ROM (Read Only Memory), a RAM (Random Access Memory), a CPU (Central Processing Unit), and the like, and that the CPU executes the predetermined program. Moreover, the classification device 10 includes an NIC (Network Interface Card) or the like, and can also communicate with another device via a telecommunication circuit such as a LAN (Local Area Network) or the Internet.

The classification device 10 includes a preprocessing unit 11, a classification unit 12, and a learning unit 13. The preprocessing unit 11 includes a mask model 111 (second model) that is a deep learning model. The classification unit 12 includes a model 121 (first model) that is a deep learning model.

The preprocessing unit 11 is provided prior to the classification unit 12, and selects an input to the model 121 by using the mask model 111. The mask model 111 is a model that minimizes a sum of a loss function that evaluates a relationship between a label on an input from teaching data and an output of the model 111, and a magnitude of the input to the classification unit 12.

The classification unit 12 performs classification by using the model 121. The model 121 is a model that performs classification and is a deep learning model.

The learning unit 13 learns the teaching data, and updates parameters of the model 121 and the mask model 111 such that the sum of the loss function and the magnitude of the input to the classification unit 12 is minimized. The learning unit 13, as will be described later, finds a gradient of the loss function by using an approximation of the Bernoulli distribution, which is a probability distribution taking two values.

In such a manner, the classification device 10 selects an input that is strongly correlated with a label by using the mask model 111 such that the sum of the loss function, which evaluates a relationship between a label on an input from the teaching data and an output of the model 121, and the magnitude of the input to the classification unit 12 is minimized, and then inputs the selected input into the model 121 of the classification unit 12. In other words, the classification device 10 masks an unrequired input that is weakly correlated with the label by using the mask model 111, prior to the model 121.

[Outline of Model Structure]

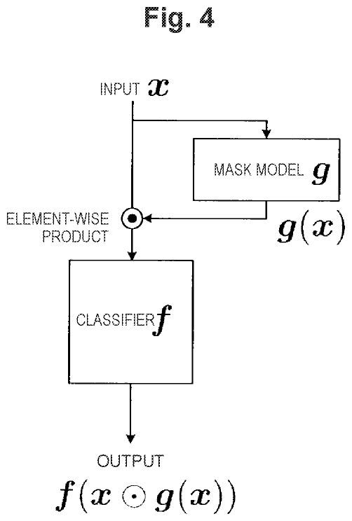

FIG. 4 is a diagram for describing an outline of a model structure in the embodiment. As shown in FIG. 4, in the classification device 10, a mask model g(●) (the mask model 111) that selects only a required input of an input x is provided prior to a deep learning classifier f(●) (the model 121). The mask model g masks the input x, and assigns “1” to a required input x and assigns “0” to an unrequired input x. The classification device 10 obtains an output expressed as Expression (8), by inputting values obtained by multiplying the input x with an output of the mask model g(●) into the classifier f(●).

[Math. 8]

f(x⊙g(x)) (8)

Here, it is assumed that dimensions of a column vector g(x) are H×W, which are the same as dimensions of an inputted image, and the number of channels is one. In Expression (8), a white circle symbol with a dot in the center denotes an operation that produces an element-wise product of g(x) and the input x, for all channels.

By setting gᵢ(x)=0 or 1, a mask model is obtained that selects only a required image pixel of the input x. However, such a model is not suitable for deep learning that uses a gradient in learning, because it is impossible to calculate differentiation with a function taking values {0, 1}, such as a step function.

To overcome such a problem, in the present embodiment, an approximation of the Bernoulli distribution using the Gumbel-max trick is used. The Bernoulli distribution B(●) is a probability distribution taking two values, and gᵢ(x)=0 or 1 can be realized by using a Bernoulli distribution as an output. In such a case, although a gradient cannot be calculated as in the case of a step function, approximate calculation as in Expressions (9) to (11) exist.

$$\begin{matrix} [ Math . 9 ] & \\ P ( {D}_{σ ( α )} = 1 ) = P ( {lim}_{τ \to + 0} G ( σ ( α ) , τ ) = 1 ) , P ( {D}_{σ ( α )} = 0 ) = P ( {lim}_{τ \to + 0} G ( σ ( α ) , τ ) = 0 ) & ( 9 ) \\ [ Math . 10 ] & \\ G ( α , τ ) = σ ( \frac{α + log ( U ) + log ( 1 - U )}{τ} ) & ( 10 ) \\ [ Math . 11 ] & \\ {D}_{σ ( α )} ∼ B ( σ ( α ) ) & ( 11 )\end{matrix}$$

Here, U is a uniform distribution. σ is a sigmoid function, which is a differentiable function, and is represented by a column vector. P(D_{σ(α)}=1) is a probability that D_{σ(α)} sampled from a Bernoulli distribution B(σ(α)) with a parameter σ(α) is “1”. P(G(α, τ)=1) is a probability that each G(α, τ) is “1”. If the calculation is performed while U is sampled from uniform distributions, a gradient of G(α, τ) with respect to α can be calculated.

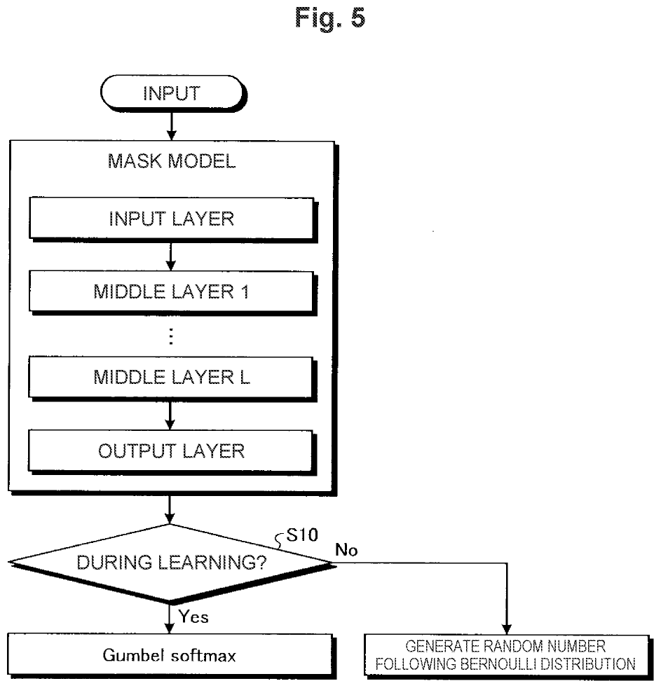

FIG. 5 is a diagram for describing a flow of processing involving the mask model. In the present embodiment, the deep learning mask model g(x) that outputs the above-described function as an output is provided prior to the classifier f. As a result, an input that is strongly correlated with a label is selected as an input to the classifier f, and an unrequired input that is weakly correlated with the label is masked prior to the model 121. During learning (step S10: Yes), for the input selected as an input to the classifier f, the classification device 10 uses the Gumbel Softmax, applies Expression (10) to find a gradient of the loss function, and updates the parameters of the model 121 and the mask model 111. When actual prediction, not learning, is performed (step S10: No), that is, when classification is performed, the classification device 10 performs classification of the input selected as an input to the classifier f, by using the Bernoulli distribution.

Here, when an output of the classifier f expressed as Expression (8) is learned in a standard manner, the learning may result in g(x) outputting “1” for all inputs, so that g(x) does not select an input.

Accordingly, in the present embodiment, an objective function at a time of learning is set as Expression (12).

$$[ Math . 12 ]$$

$$θ = arg {min}_{θ} {\sum }_{i = 1}^{N} L ( {x}_{i} , {y}_{i} , θ ) + λϕ ( g ( x ) ) \qquad ( 12 )$$

A first term of Expression (12) is a loss function that evaluates a relationship between a label on an input from teaching data and an output of the model 121. A second term of Expression (12) is a function indicating a magnitude of an input to the classification unit 12, and is a function that becomes smaller as g takes more “0”s. With respect to the second term of Expression (12), for example, Expression (13) is assumed to be established. λ is a parameter that adjusts an order of the function.

[Math. 13]

ϕ(x)=∥x⊙g(x)∥₁ (13)

As described above, Expression (12) is a function that minimizes a sum of the loss function that evaluates a relationship between a label on an input from teaching data and an output of the model 121, and the magnitude of an input to the classification unit 12, and is applied to the model 121. The learning unit 13 causes the mask model g to learn Expression (12) and then to output “0” or “1”, and thereby causes the mask model g to automatically select an input necessary to the classifier f.

Specifically, when the mask model g outputs “0”, a product with a corresponding element of an input is “0”, and the element is not selected as an input to the classification unit 12. In other words, the element of the input is masked as an unrequired input that is weakly correlated with a label. When the mask model g outputs “1”, a corresponding element of an input is selected as an input to the classification unit 12 because the element of the input is directly inputted into the classification unit 12. In other words, the element of the input is selected as an input that is strongly correlated with a label, and is inputted into the classification unit 12.

[Learning Processing]

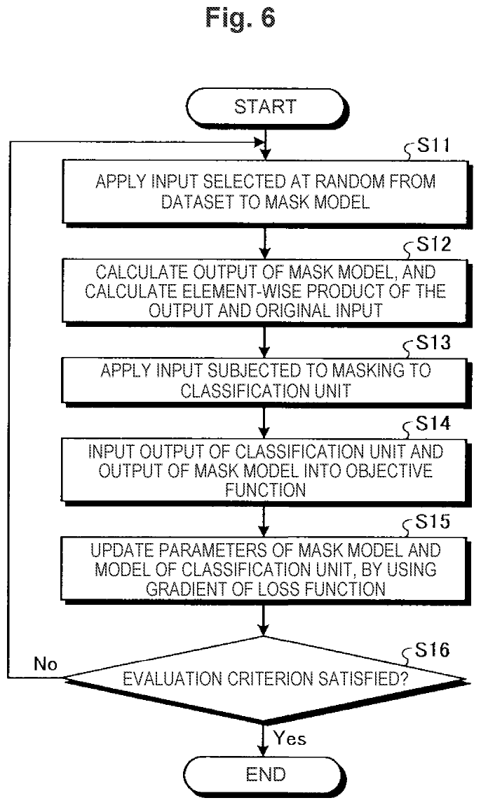

Next, learning processing involving the mask model 111 and the model 121 will be described. FIG. 6 is a flowchart showing a processing procedure of learning processing in the embodiment.

As shown in FIG. 6, the learning unit 13 selects an input and a label at random from a dataset that is prepared beforehand, and applies the input to the mask model 111 (step S11). The learning unit 13 causes an output of the mask model 111 to be calculated, and causes an element-wise product of the output and the original input to be calculated (step S12). The output of the mask model 111 is “0” or “1”. When the output of the mask model 111 is “0”, the product with the original input is “0”, and the original input is masked before inputted into the model 121. When the output of the mask model 111 is “1”, the original input is directly inputted into the model 121.

The learning unit 13 applies the input selected by the mask model 111 to the model 121 of the classification unit 12 (step S13). The learning unit 13 inputs an output of the model 121 of the classification unit 12 and the output of the mask model 111 to the objective function (see Expression (12)) (step S14).

The learning unit 13 updates the parameters of the mask model 111 and the model 121 of the classification unit 12, by using a gradient of the loss function (see Expression (10)) (step S15). Then, the learning unit 13 uses an evaluation criterion, such as whether a separately prepared dataset can be correctly classified. When it is determined that the evaluation criterion is not satisfied (step S16: No), the learning unit 13 returns to step S1 and continues learning. When it is determined that the evaluation criterion is satisfied (step S16: Yes), the learning unit 13 terminates the learning.

### Advantageous Effects of the Embodiment

As described above, the classification device 10 selects an input that is strongly correlated with a label by using the mask model 111 such that the sum of the loss function that evaluates a relationship between a label on an input from the teaching data and an output of the model 121, and the magnitude of the input to the classification unit 12 is minimized, and then inputs the selected input into the model 121 of the classification unit 12. In other words, the classification device 10 masks an unrequired input that is weakly correlated with a label, by using the mask model 111 prior to the model 121. Accordingly, according to the classification device 10, since an element that is strongly correlated with a label is inputted, the model 121 of the classification unit 12 can perform classification, without misclassification, and is also robust to an adversarial attack.

Moreover, in the classification device 10, an unrequired input that is weakly correlated with a label is masked by the mask model 111, and an element that is strongly correlated with the label is inputted into the model 121 of the classification unit 12. Accordingly, according to the classification device 10, it is easy to account for which element of an input is used in performing classification.

[System Configuration in the Embodiment]

Each component of the classification device 10 shown in FIG. 1 is a functional, conceptual component, and does not necessarily need to be configured as shown in the drawing physically. In other words, a specific form of how the functions of the classification device 10 are distributed and integrated is not limited to the form shown in the drawing, and all or a portion of the functions may be configured by being functionally or physically distributed or integrated in arbitrary units, depending on various loads and a usage condition.

An entire or any portion of each processing performed in the classification device 10 may be implemented by the CPU and a program analyzed and executed by the CPU. Each processing performed in the classification device 10 may be implemented as hardware by using a wired logic.

Of the processing described in the embodiment, an entire or a portion of processing that is described as being automatically performed may be manually performed. Alternatively, an entire or a portion of processing that is described as being manually performed may be automatically performed by using a known method. In addition, the processing procedures, control procedures, specific names, and information including various data and parameters that are described above and shown in the drawings can be changed as appropriate unless specified otherwise.

[Program]

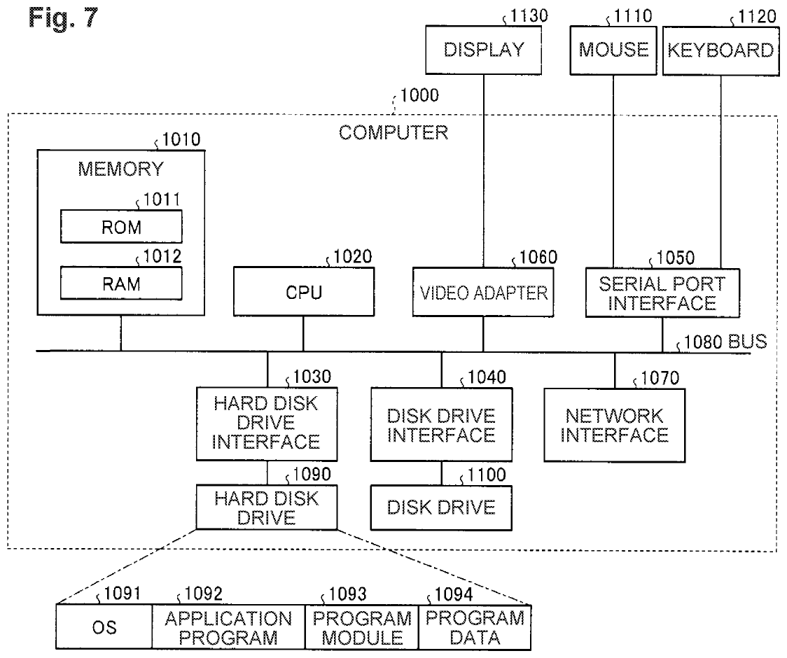

FIG. 7 shows an example of the computer on which the program is executed and thereby the classification device 10 is implemented. The computer 1000 includes, for example, a memory 1010 and a CPU 1020. The computer 1000 includes a hard disk drive interface 1030, a disk drive interface 1040, a serial port interface 1050, a video adapter 1060, and a network interface 1070. Such components are connected through a bus 1080.

The memory 1010 includes a ROM 1011 and a RAM 1012. The ROM 1011 stores, for example, a boot program such as BIOS (Basic Input Output System). The hard disk drive interface 1030 is connected to a hard disk drive 1090. The disk drive interface 1040 is connected to a disk drive 1100. A removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. In other words, programs that define each processing in the classification device 10 are packaged as a program module 1093 in which codes executable by the computer 1000 are written. The program module 1093 is stored in, for example, the hard disk drive 1090. For example, the program module 1093 for executing processing similar to the processing by the functional components of the classification device 10 is stored in the hard disk drive 1090. Note that the hard disk drive 1090 may be replaced by an SSD (Solid State Drive).

Setting data used in the processing in the above-described embodiment is stored as the program data 1094 in, for example, the memory 1010 or the hard disk drive 1090. The CPU 1020 reads into the RAM 1012 and executes as necessary the program module 1093 and the program data 1094 stored in the memory 1010 or the hard disk drive 1090.

The program module 1093 and the program data 1094, regardless of the case of being stored in the hard disk drive 1090, may be stored in, for example, a removable storage medium and read by the CPU 1020 via the disk drive 1100 or the like. Alternatively, the program module 1093 and the program data 1094 may be stored in another computer connected via a network (LAN (Local Area Network), WAN (Wide Area Network), or the like). Then, the program module 1093 and the program data 1094 may be read by the CPU 1020 from the another computer via the network interface 1070.

Although the embodiment to which the invention made by the present inventor has been described hereinabove, the present invention is not limited by the description and the drawings that are part of the disclosure of the present invention by means of the present embodiment. In other words, all of other embodiments, examples, operational techniques, and the like that can be worked by persons skilled in the art and the like based on the present embodiment are incorporated in the scope of the present invention.

### REFERENCE SIGNS LIST

10 Classification device
11 Preprocessing unit
12 Classification unit
13 Learning unit
111 Mask model
121 Model

1. A classification device, comprising:
a classifier configured to classify using a first model that is a model performing classification and includes a deep learning model; and
a preprocessor configured to, prior to the classifier classifying, select an input to the first model by using a second model that minimizes a sum of a loss function and a magnitude of the input to the classifier, the loss function evaluating a relationship between a label on an input from teaching data and an output of the first model.

2. The classification device according to claim 1, further comprising a learner configured to learn the teaching data and update parameters of the first model and the second model such that the sum of the loss function and the magnitude of the input to the classifier is minimized.

3. The classification device according to claim 2, wherein the learner determines a gradient of the loss function, by using an approximation of a Bernoulli distribution that is a probability distribution taking two values.

4. A computer-implemented method for classifying, comprising:
classifying, by a classifier, using a first model that is a model performing classification and is a deep learning model; and
selecting, by a preprocessor, an input to the first model by using a second model that minimizes a sum of a loss function and a magnitude of the input to the classifier, the loss function evaluating a relationship between a label on an input from teaching data and an output of the first model, the preprocessor executing prior to the classifier.

5. A computer-readable non-transitory recording medium storing computer-executable program instruction that when executed by a processor cause a computer system to:
classify, by a classifier, using a first model that is a model performing classification and is a deep learning model; and
selecting, by a preprocessor, an input to the first model by using a second model that minimizes a sum of a loss function and a magnitude of the input to the classifier, the loss function evaluating a relationship between a label on an input from teaching data and an output of the first model, the preprocessor executing prior to the classification step.

6. The classification device according to claim 1, wherein the second model used by the preprocessor includes a mask model masking the input based a correlation between the label on the input from teaching data and the output of the first model.

7. The computer-implemented method according to claim 4, the method further comprising:
learning, by a learner, the teaching data; and
updating, by the learner, parameters of the first model and the second model such that the sum of the loss function and the magnitude of the input to the classifier is minimized.

8. The computer-implemented method according to claim 4, wherein the second model used by the preprocessor includes a mask model masking the input based a correlation between the label on the input from teaching data and the output of the first model.

9. The computer-readable non-transitory recording medium according to claim 5, the computer-executable program instructions when executed further causing the computer system to:
learn, by a learner, the teaching data; and
update, by the learner, parameters of the first model and the second model such that the sum of the loss function and the magnitude of the input to the classifier is minimized.

10. The computer-readable non-transitory recording medium according to claim 5, wherein the second model used by the preprocessor includes a mask model masking the input based a correlation between the label on the input from teaching data and the output of the first model.

11. The computer-implemented method according to claim 7, wherein the learner determines a gradient of the loss function, by using an approximation of a Bernoulli distribution that is a probability distribution taking two values.

12. The computer-readable non-transitory recording medium according to claim 9, wherein the learner determines a gradient of the loss function, by using an approximation of a Bernoulli distribution that is a probability distribution taking two values.
